(19) United States
(12) Patent Application Publication
(10) Pub. No.: US 2025/0111668 A1
(43) Pub. Date: Apr. 3, 2025

(54) FIRE RISK DETERMINATION

(71) Applicant: Nearmap Australia Pty Ltd, Barangaroo NSW (AU)

(72) Inventors: Kitty Ka Yi LO, Barangaroo NSW (AU); Peter RICKWOOD, Barangaroo NSW (AU); Brett James TULLY, Barangaroo NSW (AU); Rohan SHAH, Barangaroo NSW (AU); Michael Stuart BEWLEY, Barangaroo NSW (AU); Song LIU, Barangaroo NSW (AU); Aert Johannes Gerardus Maria van de HULSBEEK, Barangaroo NSW (AU)

(73) Assignee: Nearmap Australia Pty Ltd, Barangaroo NSW (AU)

(21) Appl. No.: 18/895,944

(22) Filed: Sep. 25, 2024

Related U.S. Application Data
(60) Provisional application No. 63/541,260, filed on Sep. 28, 2023.

(51) Int. Cl. G06V 20/10; G01C 11/04; G06V 10/44; G06V 10/94

(52) U.S. Cl. CPC G06V 20/176; G01C 11/04; G06V 10/44; G06V 10/945; G06V 20/188

(57) ABSTRACT

A method for automatically determining a fire risk of a property utilizing machine learning to account for various features on a property, the machine learning automatically identifying features on a property relative to a building and providing weighting to the identified features based on various criteria to generate a fire score for the property and a total fire risk when the fire score is combined with a fire hazard associated with the property.

### CROSS REFERENCE TO RELATED APPLICATIONS

This application claims the benefit of U.S. Application 63/541,260, filed Sep. 28, 2023, the contents of which are incorporated by reference herein.

### BACKGROUND

### 1. Field of the Invention

The present invention relates to fire risk determination related to a property, in particular risk of wildfire damage to buildings and other property for a variety of purposes including insurance and local regulation compliance checking.

### 2. Description of Related Art

In recent years, wildfires have increased in frequency and intensity and this trend is predicted to continue due in part to climate change. Many of the recent wildfires have resulted in staggering losses, often in the billions of dollars. In recent years, the costliest wildfires have all occurred in the State of California in the United States. Against this backdrop of increasing wildfire risk, insurers must have accurate and reliable information for underwriting and pricing.

Wildfires occur with different frequency and intensity at different locations. Factors such as fuel load, temperature, wind speed, rainfall and topography are among the factors that contribute to the likelihood and intensity of a wildfire event. This combination of factors is known as the wildfire hazard where Wildfire Hazard Potential (WHP) is a wildfire hazard measure. There are five classes of hazard—1) very low, 2) low, 3) moderate, 4) high, and 5) very high, along with a class for unburnable (which are often developed urban areas and bodies of water). Most of the wildfire hazards in the United States are concentrated in the western states, but there are pockets of wildfire hazards elsewhere. Gregory K. Dillon, James Menakis, Frank Fay, 2015; “Wildland fire potential: A tool for assessing wildfire risk and fuels management needs”; 2015 available at www.fs.usda.gov/rm/pubs/rmrs_p073/rmrs_p073_060_076.pdf. Robert E. Keane, Matt Jolly, Russell Parsons, Karin Riley, “Proceedings of the large wildland fires conference; May 19-23, 2014; Missoula, MT”; Proc. RMRS-P-73. Fort Collins, CO: U.S. Department of Agriculture, Forest Service, Rocky Mountain Research Station, 2015 available at www.fs.usda.gov/rm/pubs/rmrs_p073.pdf.

The Wildland Urban Interface (WUI) is the transitional zone between built-up and forested areas. It is known that WUI areas have relatively higher wildfire hazards, but despite this risk, WUIs are growing rapidly, with more than 2 million acres added per year in the USA as of June 2022. A. R. Carlson, D. P. Helmers, T. J. Hawbaker, M. H. Mockrin and V. C. Radeloff, 2022, Wildland-urban interface maps for the conterminous U.S. based on 125 million building locations: U.S. Geological Survey data release, available at www.usgs.gov/data/wildland-urban-interface-maps-conterminous-us-based-125-million-building-locations; see also, https://doi.org/10.5066/P94BT6Q7.

While a building in a wildfire perimeter may be damaged by a wildfire, not all properties in the perimeter will always be damaged. The risk of damage to a specific property depends on local factors and is known as vulnerability. Unlike wildfire hazard, homeowners can reduce wildfire vulnerability. Two ways to reduce this vulnerability are: 1) building with fire-proof materials, and 2) creating a defensible space around the property and structures.

Defensible space is a buffer between a property and vegetation or other combustible materials in the vicinity. Creating and maintaining defensible space can reduce wildfire risks because less fuel around a structure means there is less material to burn, leading to lower wildfire intensity and slower speed of spread. In California, homeowners are required to maintain a 100 feet defensible zone. See e.g., https://readyforwildfire.org/prepare-for-wildfire/. The overall fire risk depends on both wildfire hazard and vulnerability.

To estimate the overall fire risk of properties, accurate practical methods of assessing fire risk vulnerabilities are needed.

### SUMMARY

The present invention addresses, but is not limited to, the issues of assessing fire risk in real time, assessing fire risk in the future, validating customer information, ensuring insurance or government policy compliance, and pre-filling insurance and/or other forms and/or applications.

As part of the present invention, an interactive interface computes metrics based on aerial images and pre-computed features created from aerial images using a classifier that corresponds to objects on the ground seen during surveys. Additional inputs include, but are not limited to, maps, weather, terrain, historical data, and fire hazard information.

One method includes the steps of: 1) Selecting a property. 2) Extracting features from aerial images on the property, including e.g., vegetation, debris, waste, and flammable materials, as well as determining metrics such as lengths relating to power poles, and so on. 3) Identifying one or more building structures. 4) Filtering features with respect to zones and parcel boundaries including, e.g., swimming pool(s) within a zone and within a parcel; vegetation within one or more zones (e.g., leaf off); including weighting related to topology (e.g., slope) on the property. 5) Pre-filling an insurance application, including, in one version, checking for compliance. 6) Averaging over multiple surveys. 7) Combining the above determinations with a hazard score to generate a measure of fire risk.

One configuration, a vulnerability metric for a specific property is generated. Additionally, the generated vulnerability metric is combined by the API with a hazard metric associated with the property location.

Another configuration utilizes features stored in vector layers and aligned with image data. The vector layers define regions that include pre-defined classes of content including for example, building structures, vegetation, debris, and so forth).

Still another configuration includes defensible zones that include areas matching different features within dilated regions (zones) around a property. Metrics are computed accounting for the presence of features, combined area, or other computed quantities including for example, a relative geometry of the features and the zones. Other factors that are considered include “in-parcel features” that connect a feature with the parcel boundary of a property. For example, a swimming pool might have a greater impact in terms of reducing fire risk for structures within the same parcel but a lower impact if it is in a neighboring property (out-of-parcel feature). Additionally, vegetation, debris or power lines within parcel boundaries (in-parcel features) may be weighed differently from the same features outside the boundary (out-of-parcel feature) as the boundary gives an indication of the level of control the owner has over the underlying ground objects corresponding to the features.

The adjacency of features to a structure is also accounted for. For example, a deck that touches a building footprint presents a higher risk than a disconnected deck. Adjacency may be strict or approximate. Adjacent feature metrics may be generated based on the relative geometry of features and a building outline, flammability/combustibility of materials, and other related properties. For example, a stone patio the extends up to a house will have a lower fire risk than a raised wooden deck that is disconnected from the house.

Another configuration considers overlap of features with a structure. For example, a tree overhanging a building footprint presents a higher risk than a tree that is located a distance from the home and does not overlap the building footprint. Overlapping feature metrics may be generated based on the relative geometry of features and building outline, combustibility of materials, and other related properties.

It is further contemplated that near infrared (NIR) imagery can be used to estimate health and moisture levels in vegetation. Very dry vegetation presents a much higher risk than vegetation with a high moisture content. Other embodiments may use Infrared, multispectral or hyperspectral images.

There are various mechanisms that can be used to improve the estimated fire hazard. For example, time averaging over several surveys, the timing of survey relative to weather data information, property geometry, (e.g. distance, direction, slope to vegetation, other geometric relationships), and analysis of multiple image sources and modalities, such as aerial, drone, satellite and resulting AI data. Finally, any nearby fires (current or historical), and any condition(s) that may cause or contribute to such fires may be accounted for.

There are various weightings that may be applied to identified features on a property based on a variety of factors. These weightings may include, but are not limited to, any of the following: moisture-weighting for identified vegetation, geometry-weighting associated with a geometry of an identified feature; overlap-weighting for features that are determined to overlap each other on the property; zone-weighting associated with features located in identified zones relative to a building; feature-weighting associated with an identification of the feature itself; parcel-weighting associated with a feature based on a location of the feature relative to a parcel boundary; and topology-weighting associated with a topology of the property.

In one configuration, a method for automatically determining fire risk of a property with a computer having a network connection and connected to a storage and utilizing machine learning is provided, the method comprising the steps of: identifying a property based upon input data received by the computer, retrieving an aerial image corresponding to the property, and identifying features associated with the property based on an analysis of the aerial image and based on data accessible by the machine learning stored in the storage. The method further comprises the steps of: identifying one or more buildings on the property, calculating a fire score based on the identification of the features and the one or more building one the property, and outputting the fire score.

The above-described and other features and advantages of the present disclosure will be appreciated and understood by those skilled in the art from the following detailed description, drawings, and appended claims.

### DESCRIPTION OF THE DRAWINGS

FIG. 1 is a block diagram of the system for determining fire risk for a property according to one configuration of the invention.

FIG. 2 is a table that lists example classes and sub-classes of features and associated metrics for the system according to the system of FIG. 1.

FIG. 3 is a process flow diagram for machine learning feature classification according to the system of FIG. 1.

FIGS. 4A and 4B depict aerial views of several buildings, around a property parcel showing features related to the fire hazard used by the system of FIG. 1.

FIG. 5 is a process flow diagram for determining fire risk assessment related metrics, data, and other outputs according to the system of FIG. 1.

FIGS. 6A and 6B depict outlines from an aerial view of a property illustrating the building outline and zones according to the aerial views of FIGS. 4A and 4B respectively.

FIG. 7A depicts outlines from an aerial view of a property illustrating medium/high vegetation features according to the aerial views of FIGS. 4A and 6A.

FIG. 7B depicts outlines from an aerial view of a property illustrating medium/high vegetation features according to the aerial views of FIGS. 4B and 6B.

FIG. 7C depicts an aerial view of the property that illustrates a feature related to leaf off vegetation around the property with respect to the zones and the property boundary according to FIG. 7A.

FIG. 7D depicts an aerial view of the property that illustrates a feature related to leaf off vegetation around the property with respect to the zones and the property boundary according to FIG. 7B.

FIG. 7E depicts an aerial view of the property that illustrates swimming pools features around the property with respect to the zones and the property boundary according to the aerial views of FIGS. 4A and 6A

FIG. 7F depicts an aerial view of the property that illustrates swimming pools features around the property with respect to the zones and the property boundary according to the aerial views of FIGS. 4B and 6B.

FIG. 8 depicts a table that lists overview data for the property according to the system of FIG. 1.

FIG. 9 depicts a table that lists feature classification data according to the system of FIG. 1.

FIG. 10 depicts a table that lists 3D topology data according to the system of FIG. 1.

### DETAILED DESCRIPTION

An embodiment of the invention provides high resolution spatio-temporal information on one or more properties by using wide scale, high resolution aerial imagery captured at in one epoch or in multiple epochs. Images may include grayscale, RGB, or multispectral images having a resolution in the order of centimeters and could include infrared (IR) and/or Near infrared (NIR) imagery.

The aerial images may be used to create several useful image-based products for the survey region, including: photomosaics that comprise orthomosaic and panoramas; oblique imagery; 3D models (with or without texture); projected 3D models; and raw image viewing tools. Photomosaics and 3D products such as 3D mesh, digital elevation model (DEM) or digital surface model (DSM), provide seamless coverage over one or more survey regions making them valuable for visualization, image analysis, and assessment of ground features. The aerial imagery and derived products may be stored in one or more aerial imagery databases. The image-based products may be georeferenced to known geographic reference grids, such as by latitude and longitude. The geometry of features derived from the image-based products would therefore also be georeferenced to the same reference grids.

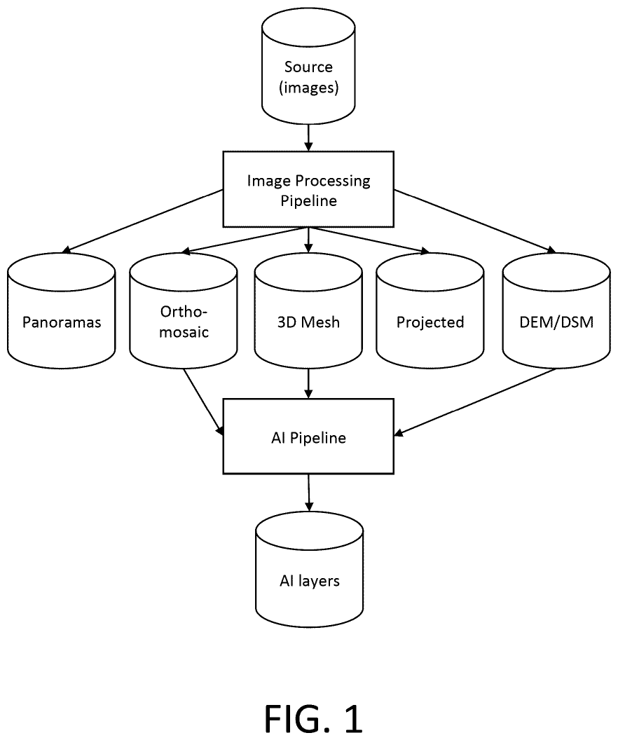

Turning now to the figures, FIG. 1 illustrates processing of aerial imagery according to an advantageous configuration. Source images are processed by the image processing pipeline to create panoramas, ortho-mosaics, 3D textured mesh, projected 3D images, and DEM/DSM products. The artificial intelligence (A.I.) pipeline processes a subset of these image products to generate features (e.g., A.I. layers that may be vector or raster or a combination of both).

In one configuration, processing is carried out by a system that includes one or more processors, memory, and a storage subsystem. The system is part of a computer network, and may include virtual processors.

The A.I. pipeline in one configuration comprises one or more special processing engines designed for carrying out A.I. processes. In addition to the aerial image-based data, the A.I. pipeline of some embodiments may use:
Historical data related to weather or climate events for the survey region.
Data related to properties in the survey region such as, boundary information. including parcel boundary data, insurance information, information related to building materials (i.e., data related to flammability), planning and construction data such as, timeline information, and any other related information.
3D data such as DEM or DSM data.
Historical and current data related to wildfires and other events. This may include,
   Fire-related properties of the construction materials, in particular, data related to flammability and combustibility, (e.g., fire resistance materials would have very different flammability and combustibility compared to untreated wood, while specific cladding and roofing materials are known to increase the fire risk at a property). In some cases, these properties may be estimated based on an analysis of the aerial imagery such as using imagery from multiple views or multiple parts of the electromagnetic spectrum.
   Fire-related properties of vegetation, in particular, data related to flammability and combustibility, (e.g., dry and woody vegetation is known to be more prone to burning, while damp and green vegetation is less prone to burning). In some cases, these properties may be estimated based on an analysis of the aerial imagery using imagery from multiple views or multiple parts of the electromagnetic spectrum.
   Multi-spectral satellite data, including but not limited to, Infrared imaging.
   Information related to accessibility of property such as, distance to the nearest arterial road.

It should be noted that this additional data may also be stored in the aerial imagery database or may be accessed/accessible from another source.

In one configuration, the system is updated in real time to reflect latest information. For example, as new aerial imaging products become available, they are processed to generate updated features and metrics that can be used independently or in combination with historical imaging data and derived features to calculate fire risk related information. For example, as new weather, wildfire, fire hazard, insurance, government, or other data becomes available, it is used independently or in combination with historical data to calculate updated fire risk related information. This means that when a user requests information relating to a property, they are presented with current information at the property location.

One configuration uses overhead imagery to detect object types on the ground including, but not limited to vegetation, buildings, bodies of water (e.g., swimming pools), power poles, debris and wreckage, decking, roads, cars, etc. This may be achieved using semantic segmentation, where regions associated with different object types can be determined within the imagery. The generated output is referred to as feature layers (or features), where each feature layer defines the geometry corresponding to a particular object.

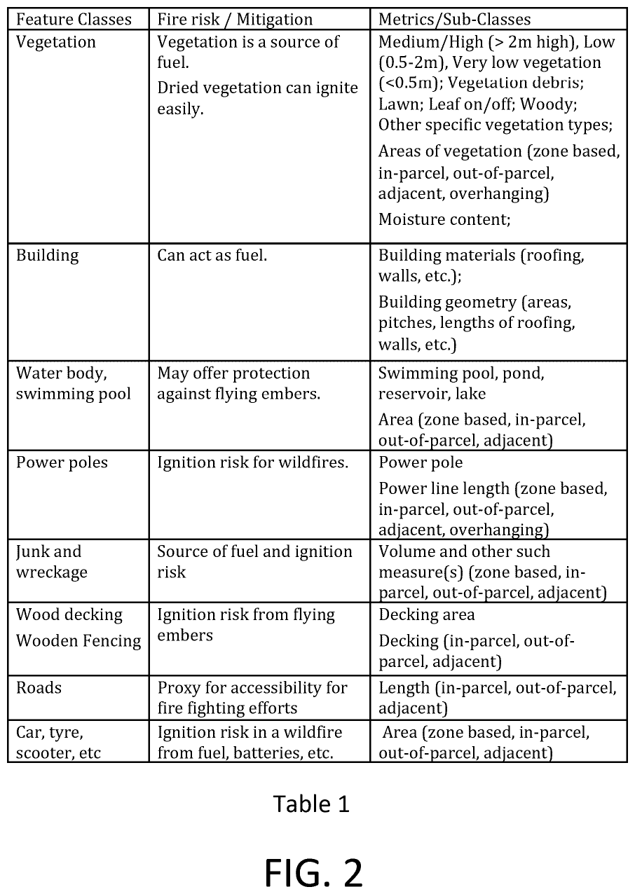

FIG. 2 comprises Table 1 that lists example classes and sub-classes of features and associated metrics. It will be understood by those of skill in the art that this list is not limiting. One configuration uses machine learning models trained to analyze/detect sets of classes of objects including to those listed in Table 1 from a vertical photomap constructed by combining aerial images taken at or close to nadir. These models utilize semantic segmentation or instance segmentation. They are typically trained with target labels having been generated via expert human labelling. Optionally, the models may have been pre-trained using unsupervised, or self-supervised techniques. The machine learning models may be deep learning models or other models suitable to generate a segmentation from an image. Alternative models include thresholding, histogram-based techniques, region growing, k-means clustering, watersheds, active contours, graph cuts, conditional and Markov random fields, and sparsity-based methods.

The models are situated within a broader pipeline of algorithms including computational geometry, such as polygon normalization or simplification or morphological operations, and geospatial algorithms such as, clipping or intersection or overlay with either other vector features or raster pixels, to enrich objects with attributes derived from the vertical photomap and other sources such as 3D mesh data. An alternative embodiment uses an orthographic (top down) projection from a 3D mesh, and yet another embodiment uses other suitable projection of the 3D mesh. Other configurations may also use 3D data such as DEM or DSM data to improve the accuracy of the classifications and estimates, or NIR data to provide information relating to vegetation and moisture.

Classification feature layers of object types such as, buildings, vegetation, swimming pools, decks etc. may be generated for multiple aerial image surveys performed over a set of dates to create a historical database of classification features. The features may be stored in raster format (i.e., defined on a grid on the ground and stored in a 2D image type format) or a vector format (i.e., defined as vector regions, for example, though a set of polygon objects with classification information). The classification feature data may be stored in the aerial imagery database or may be accessible from another source.

In addition to classifying features on the ground, some configurations of the invention may use metric data derived from attributes of the classified features. These may include, but are not limited to:
Height or moisture level of vegetation (e.g., moisture levels via NIR imagery).
Geometry of building features (e.g., roof area, pitch, window area, door area, etc.).
Attributes of building features such as, roof condition or material.
Length of power lines. The metric data may be stored in connection with raster or vector classified objects as described above.

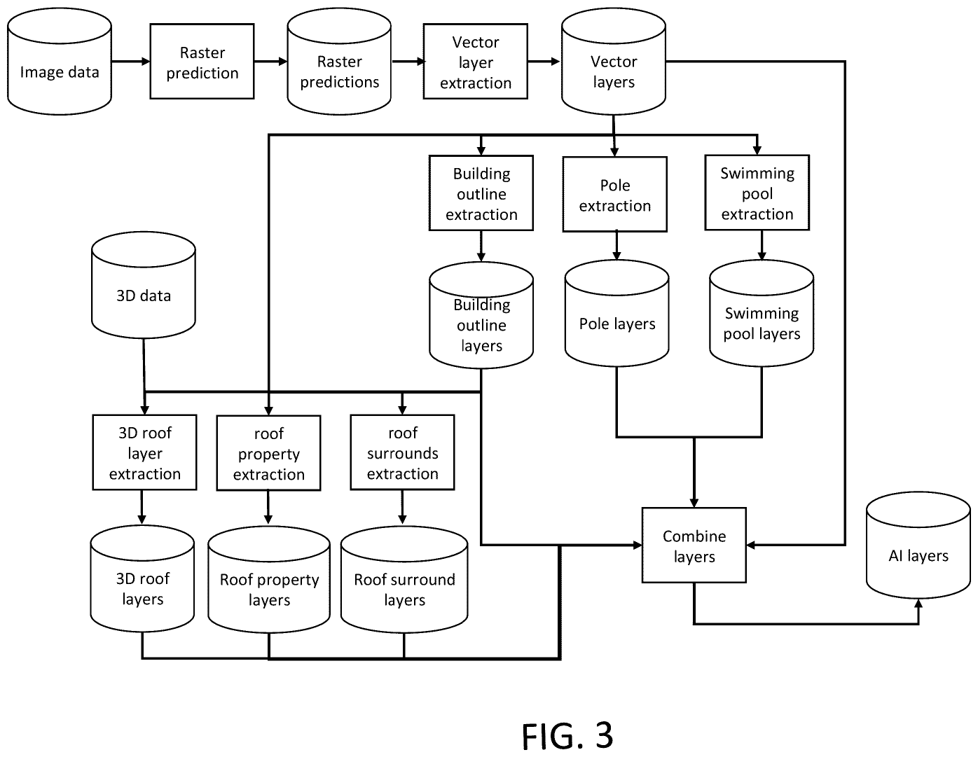

FIG. 3 depicts processing flow for machine learning feature classification according to one configuration. The processing pipeline inputs images and 3D data from which it generates various features and metrics in vector and raster format through multiple processing stages generating and combining vector layers of features. The 3D data may comprise DEM, 3D mesh such as from a 3D textured mesh, or DSM.

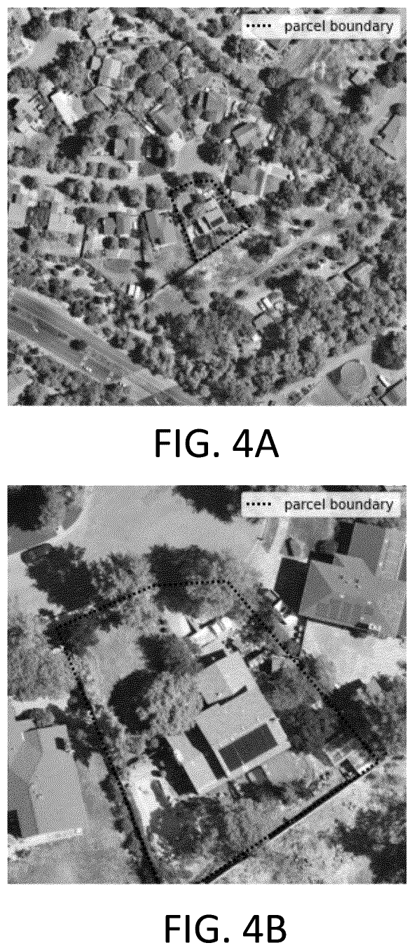

FIGS. 4A and 4B depict aerial views of several buildings, around a specific property parcel showing features related to the fire hazard for some of these buildings. These features include, for example, the vegetation and the swimming pools present near some of the buildings.

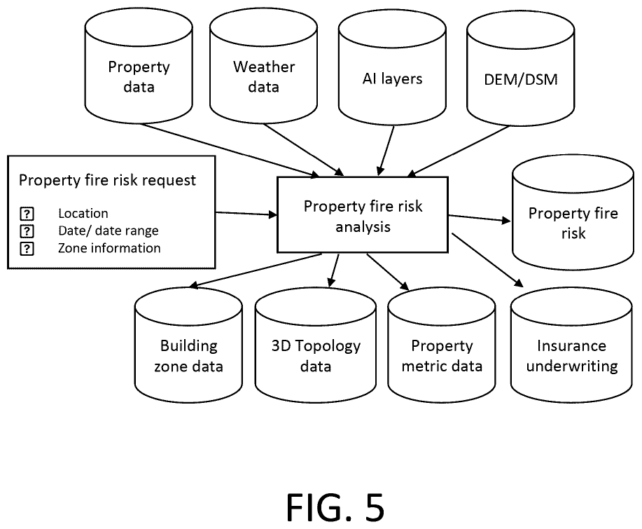

FIG. 5 depicts a configuration of a system for determining fire risk assessment related metrics, data, and other outputs such as auto-generated insurance underwriting outputs (pre-filled insurance forms, property compliance checks).

One aspect of this configuration includes using an interactive system that allows fire risk assessment related metrics to be requested for a specific property. The system looks up data from the aerial imagery database (and possibly elsewhere) to generate the metrics. The property may be requested based on one or more inputs including for example, 1) An address or street address; 2) A geographical location (e.g., by a latitude and longitude or a geocode); 3) A property ID; and 4) Any other information that may be used to identify one or more locations in the property or associated with the property boundary.

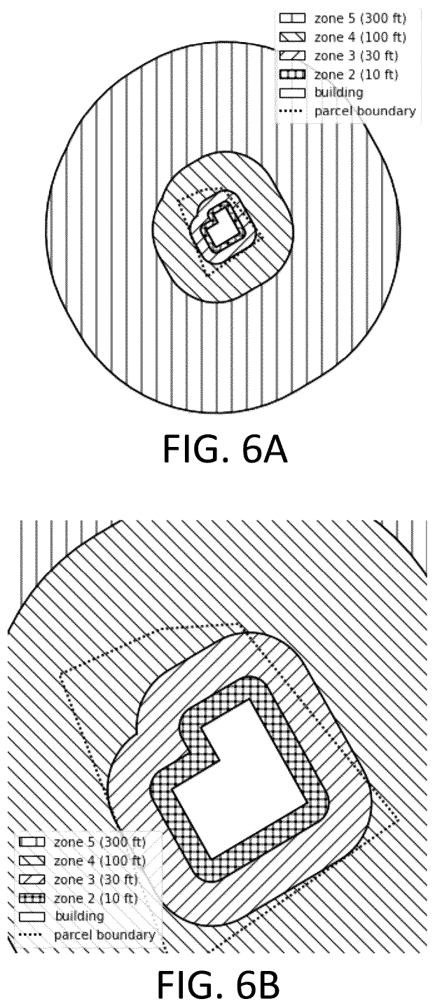

Turning now to FIGS. 6A and 6B, in one configuration the system uses building outlines for the requested property location. For example, the system may use vector or raster machine learning building outlines generated from aerial imagery. Alternatively, property outlines may be input from construction plans, council planning data, and/or other sources. It is further contemplated that the system may generate geometric regions, or zones around the property building outlines (e.g., the generated regions could be 0-5 ft, 0-10 ft, 0-30 ft, 0-100 ft and/or 0-300 ft). However, the generated regions may be defined based on other information such as local regulations, or specific requirements of a user (e.g., an insurance underwriter), which may be an optional input to the interactive system.

The zones may be determined by a morphological operation around the building outlines such as a dilation. The operation may be performed using vector data such as polygons, or raster data such as an image, or a combination thereof. Each of FIGS. 6A and 6B depict outlines from an aerial view of a property illustrating the building outline and 4 zones at 300, 100, 30 and 10 feet. The region shown in FIG. 6A corresponds to the aerial view shown in FIG. 4A, and the region shown in FIG. 6B corresponds to the aerial view shown in FIG. 4B.

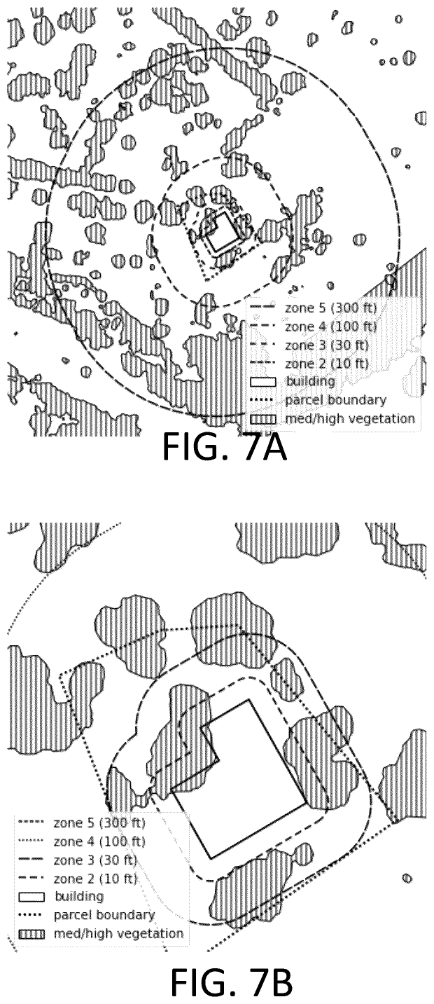

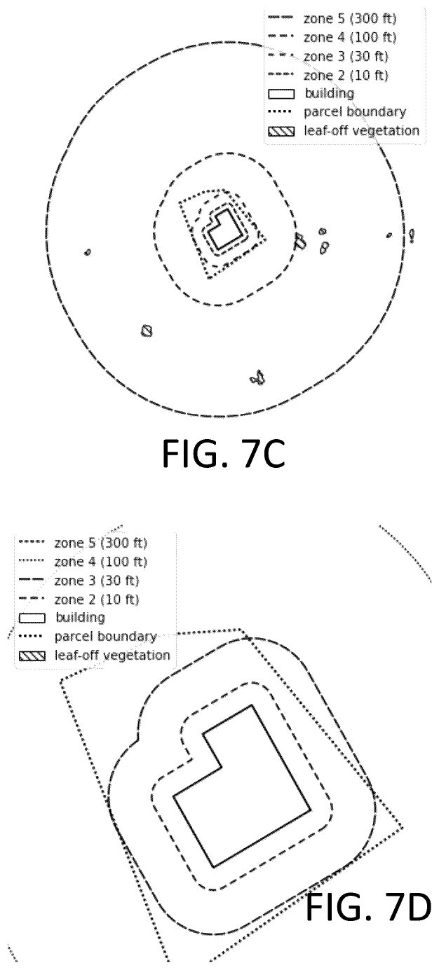

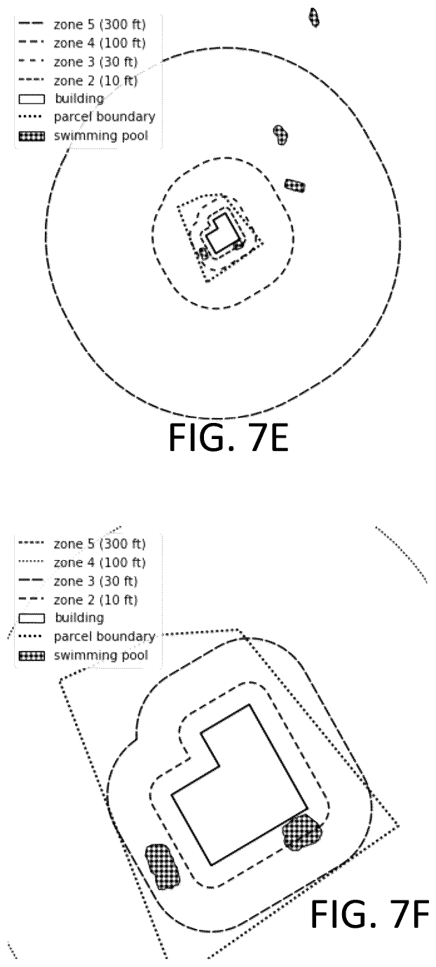

Referring now to FIGS. 7A and 7B, an aerial view of the property illustrates features of medium/high vegetation around the property with respect to the zones and the property boundary. The region shown in FIG. 7A corresponds to the aerial view shown in FIG. 4A and FIG. 6A, and the region shown in FIG. 7B corresponds to the aerial view shown in FIG. 4B and FIG. 6B. For this property, medium/high vegetation is seen in all zones, both within and outside the parcel boundary. It is also seen overhanging the building itself, which is an adjacent and overlapping feature.

Each of FIGS. 7C and 7D shows an aerial view of the property that illustrates a feature related to leaf off vegetation around the property with respect to the zones and the property boundary. The region shown in FIG. 7C corresponds to the aerial view shown in FIG. 4A and FIG. 6A. The region shown in FIG. 7D corresponds to the aerial view shown in FIG. 4B and FIG. 6B. For this property, leaf off vegetation is predominantly found outside the parcel boundary and outside zones 2, 3 and 4.

FIGS. 7E and 7F shows an aerial view of the property that illustrates swimming pools features in and on the property with respect to the zones and the property boundary. The region shown in FIG. 7E corresponds to the aerial view shown in FIG. 4A and FIG. 6A. The region shown in FIG. 7F corresponds to the aerial view shown in FIG. 4B and FIG. 6B. There are two swimming pools features regions within zone 3 that are also within the parcel boundary. There are also two swimming pools in zone 5 that are outside of the parcel boundary and one that is outside the zones and the parcel boundary.

The area of each zone is calculated, and within each zone, the sub-area corresponding to feature classes is determined from the classification feature data. Metric data may also be combined corresponding to each zone (e.g., the areas or lengths of specific items may be added together, heights may be combined statistically by averaging).

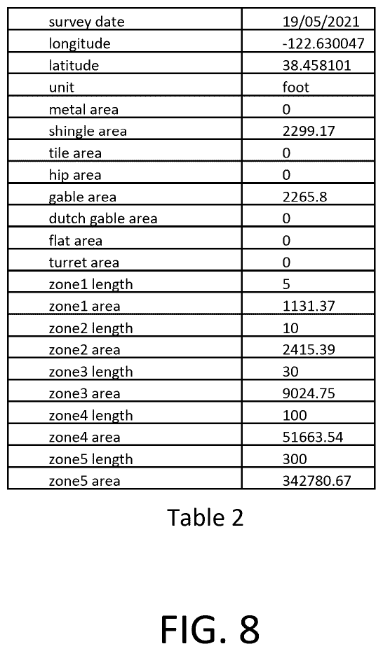

FIGS. 8-10 depict Tables 2, 3, and 4, respectively include data calculated for a property generated based on a survey at a specific date.

FIG. 8 Table 2 shows the overview data for the property including survey date, location information (latitude and longitude), roofing information including areas of specific roofing material types, and zone information including areas of 5 zones at distances of 5-300 ft from the building outline.

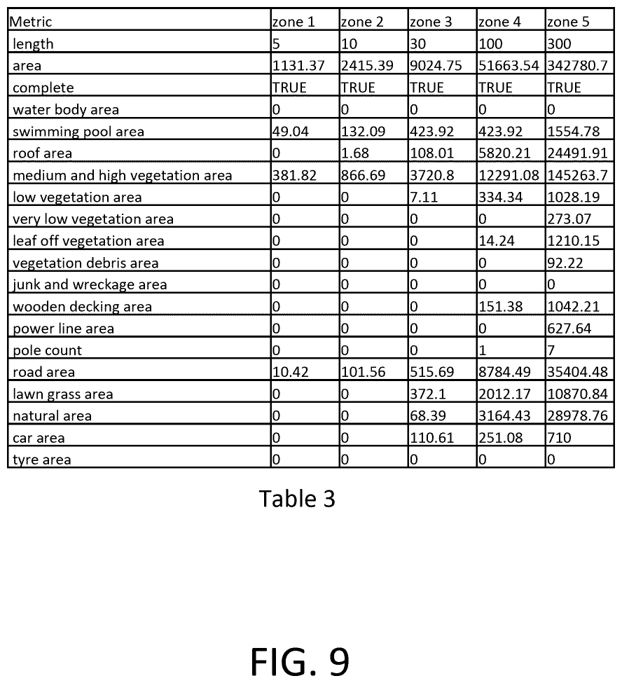

FIG. 9 Table 3 shows feature classification data for zones 1-5, including areas corresponding to specific feature classes.

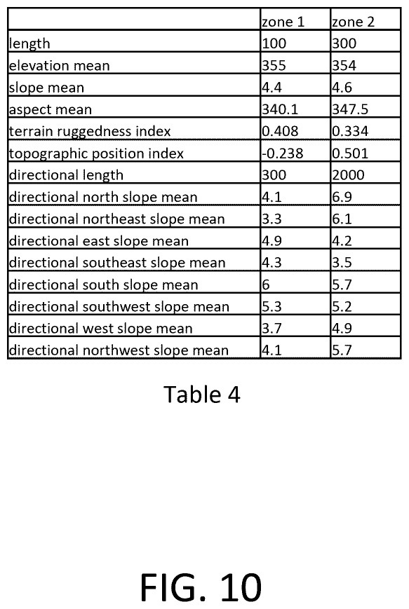

FIG. 10 Table 4 shows 3D topology data corresponding to, for example, the slope across two zones.

The configurations described above use image products derived from a single survey at a particular time or epoch. However, alternative embodiments may use image products from multiple surveys and multiple times or epochs. In this way, a more accurate assessment may be formed by, for example, averaging, interpolation or extrapolation. For example, it is contemplated that imaging of a property may occur on a first date. That imaging may comprise many different images that are variously processed to provide high detail of the property. At a later date (e.g., six months) other image(s) of the property may be captured. This can be repeated numerous times (multiple epochs) allowing a user to see not only up-to-date information relating to the property, but allows for a historical review of the property over time (filtered by date or a range of dates), which can be very helpful, for example, for an insurance company in determining: rates for the property, or for compliance with terms of an insurance contract. Alternatively, this feature could enable an insurance company to work with a property owner on how to lower rates by making adjustments to the property to lower fire risk and further allows the company to confirm such adjustments have been made and are being maintained as the insurance company can access images of the property filtered by date or a range of dates.

Another configuration of the system includes analyzing the local DEM around buildings on the property being investigated to determine geometric properties. For example, in one configuration, the following data may be calculated:
Slope information within zones along cardinal directions.
Terrain ruggedness within zones.
Elevation and aspect within a zone.
Ridges, valleys, and other topological features near the property.

This information can be valuable because those familiar with fire dynamics understand that fires tend to move faster when burning upslope than downslope. In some instances, ridges can make good places for fire containment or breaks because fire spread can slow near the top of a ridge.

Another configuration of the system includes performing calculations that compare property boundary information with feature information. For example, the existence of a swimming pool within the property boundary may be determined by comparing A.I. layer data with property boundary data. Swimming pools on the property of a structure may reduce the risk of wildfire damage by more than swimming pools near a structure but on an adjacent property. On the other hand, debris around a structure as well as flammable decking increases the risk of wildfire damage.

The zones may be modified to limit to the regions within the property boundary and various areas may be re-calculated. This can enable an insurance company to determine:
Compliance of the property with local laws.
How much control the property owner has over features that increase a fire risk, and therefore the potential to reduce that risk reducing the insurance premium.
Ongoing accuracy of the insurance data for the property, and changes to the fire risk at the property.

The system may also be configured to automatically generate an overall fire risk score for a property. This score may be a percentage value generated based on one or more factors including:
The zone data for the property calculated as described above.
In-parcel and out-of-parcel metrics calculated as described above.
Adjacency metrics calculated as described above.
Fire hazard data or other similar information for the property location.
Topological information.
Historical weather data.
Construction details for the property such as materials lists and designs.
Insurance data for the property, neighboring properties, or regional insurance data associated with the property.

The fire risk score may be a vulnerability (not considering the fire hazard at the location) or may be weighted according to a fire hazard score at the location. For example, supervised machine learning models may be trained to output a fire risk score based on features such as the vector layers described above, and/or derived metrics and parameters based on those features including zone metrics, in-parcel and out-of-parcel metrics, and adjacency metrics. Supervised machine learning models require labelled data for the machine learning model. Algorithms for performing this may be based on regression, for example logistic regression, multivariate linear regression, tree-based algorithms, and/or ensemble algorithms like gradient boosted trees or random forest. Fire damage labels corresponding to the features may be created from external data sources such as insurance claims, based on fire damage seen on properties within aerial or other images or derived image products, knowledge of wildfire events, other reports or sources of information related to wildfire damage. The machine learning model combines all relevant features into one fire risk score. The risk score predicts the probability of damage on the condition that a wildfire occurs in the vicinity of the property.

The fire risk score, or other metrics may be customized to a property, or customer of an insurance company, or an insurance company or local council. For example, each insurer may have their own criteria, internal processes, definitions and requirements in relation to wildfire events and damage.

Unless specifically stated otherwise, as apparent from the following, it is appreciated that throughout the specification discussions utilizing terms such as “processing,” “computing,” “calculating,” “determining” or the like, may refer to, without limitation, the action and/or processes of hardware, e.g., an electronic circuit, a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements, e.g., of such steps is implied, unless specifically stated.

The methodologies described herein are, in some embodiments, performable by one or more processors of a processing system, or, as indicated above, one or more client processors of a client processing system. The processor(s), in either case, accept logic, instructions encoded on one or more computer-readable media. When executed by one or more of the processors, the instructions cause carrying out at least one of the methods described herein. Any processor capable of executing a set of instructions (sequential or otherwise) that specify actions to be taken is included. Thus, one example is a typical processing system that includes one or more processors. Each processor may include one or more of a CPU or similar element, a graphics processing unit (GPU), field-programmable gate array, application-specific integrated circuit, and/or a programmable DSP unit. The processing system further includes a storage subsystem with at least one storage medium, which may include memory embedded in a semiconductor device, or a separate memory subsystem including main RAM and/or a static RAM, and/or ROM, and cache memory. The storage subsystem may further include one or more other storage devices, such as magnetic and/or optical and/or further solid-state storage devices. A bus subsystem may be included for communicating between the components. The processing system further may be a distributed processing system with processors coupled by a network, e.g., via network interface devices or wireless network interface devices. If the processing system requires a display, such a display may be included, e.g., a liquid crystal display (LCD), organic light emitting display (OLED), or a cathode ray tube (CRT) display. If manual data entry is required, the processing system also includes an input device such as one or more of an alphanumeric input unit such as a keyboard, a pointing control device such as a mouse, and so forth. The term storage device, storage subsystem, or memory unit as used herein, if clear from the context and unless explicitly stated otherwise, also encompasses a storage system such as a disk drive unit. The processing system in some configurations may include a sound output device, and a network interface device.

Such a computer may be a standard computer system used for serving information to clients, e.g., clients connected via a network. The client device, in one embodiment, is a mobile device, such as a smart phone (e.g., iphone, Android phone, or some other type of smart phone), a tablet (e.g., iPad, Android tablet, Microsoft Surface, etc.), a mobile music player that has a screen and a real or virtual, i.e., displayed keyboard, and so forth. Such devices have small screens, so that being able to avoid needing to display a traditional results web page provides some advantage.

In some embodiments, a non-transitory computer-readable medium is configured with, e.g., encoded with instructions, e.g., logic that when executed by one or more processors, e.g., the processor of a mobile device and the one or more processors of a server device. A processor may be a digital signal processing (DSP) device or subsystem that includes at least one processor element and a storage subsystem containing instructions that when executed, cause carrying out a method as described herein. Some embodiments are in the form of the logic itself. The term “non-transitory computer-readable medium” thus covers any tangible computer-readable storage medium. In a typical processing system as described above, the storage subsystem thus includes a computer-readable storage medium that is configured with, e.g., encoded with instructions, e.g., logic, e.g., software that when executed by one or more processors, causes carrying out one or more of the method modules (of one or more steps) described herein. The software may reside in the hard disk, or may also reside, completely or at least partially, within the memory, e.g., RAM and/or within the processor registers during execution thereof by the computer system. Thus, the memory and the processor registers also constitute a non-transitory computer-readable medium on which can be encoded instructions to cause, when executed, carrying out method steps. Non-transitory computer-readable media include any tangible computer-readable storage media and may take many forms including non-volatile storage media and volatile storage media. Non-volatile storage media include, for example, static RAM, optical disks, magnetic disks, and magneto-optical disks. Volatile storage media includes dynamic memory, such as main memory in a processing system, and hardware registers in a processing system.

While the computer-readable medium is shown in an example embodiment to be a single medium, the term “medium” should be taken to include a single medium or multiple media (e.g., several memories, a centralized or distributed database, and/or associated caches and servers) that store the one or more sets of instructions. Furthermore, a non-transitory computer-readable medium, e.g., a computer-readable storage medium may form a computer program product or be included in a computer program product.

In alternative configuration, the one or more processors operate as a standalone device or may be connected, e.g., networked to other processor(s), in a networked deployment, or the one or more processors may operate in the capacity of a server or a client machine in server-client network environment, or as a peer machine in a peer-to-peer or distributed network environment. The term processing system encompasses all such possibilities, unless explicitly excluded herein. The one or more processors may form a personal computer (PC), a media playback device, a headset device, a hands-free communication device, a tablet PC, a set-top box (STB), a Personal Digital Assistant (PDA), a game machine, a cellular telephone, a Web appliance, a network router, switch or bridge, or any machine capable of executing a set of instructions (sequential or otherwise) that specify actions to be taken by that machine.

Note that while some diagram(s) only show(s) a single processor and a single storage subsystem, e.g., a single memory that stores the logic including instructions, those skilled in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

It will be appreciated by those of skill in the art that configurations of the present invention may be embodied as a method, an apparatus such as a special purpose apparatus, an apparatus such as a method, logic, e.g., embodied in a non-transitory computer-readable medium, or a computer-readable medium that is encoded with instructions, e.g., a computer-readable storage medium configured as a computer program product. The computer-readable medium is configured with a set of instructions that when executed by one or more processors cause carrying out method steps. Accordingly, aspects of the present invention may take the form of a method, an entirely hardware embodiment, an entirely software embodiment or an embodiment combining software and hardware aspects. Furthermore, the present invention may take the form of program logic, e.g., a computer program on a computer-readable storage medium, or the computer-readable storage medium configured with computer-readable program code, e.g., a computer program product.

It will also be understood that configurations of the present invention are not limited to any implementation or programming technique and that the invention may be implemented using any appropriate techniques for implementing the functionality described herein. Furthermore, embodiments are not limited to any programming language or operating system.

Similarly, it should be appreciated that in the above description various features of the invention are sometimes grouped together in a single configuration, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified, the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Any discussion of other art in this specification should in no way be considered an admission that such art is widely known, is publicly known, or forms part of the general knowledge in the field at the time of invention.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting of only elements A and B. Any one of the terms including or which includes or that includes as used herein is also an open term that also means including at least the elements/features that follow the term, but not excluding others. Thus, including is synonymous with and means comprising.

Similarly, it is to be noted that the term coupled, when used in the claims, should not be interpreted as being limitative to direct connections only. The terms “coupled” and “connected,” along with their derivatives, may be used. It should be understood that these terms are not intended as synonyms for each other but may be. Thus, the scope of the expression “a device A coupled to a device B” should not be limited to devices or systems wherein an input or output of device A is directly connected to an output or input of device B. It means that there exists a path between device A and device B which may be a path including other devices or means in between. Furthermore, coupled to does not imply direction. Hence, the expression “a device A is coupled to a device B” may be synonymous with the expression “a device B is coupled to a device A.” “Coupled” may mean that two or more elements are either in direct physical or electrical contact, or that two or more elements are not in direct contact with each other but still co-operate or interact with each other.

In addition, use of the “a” or “an” are used to describe elements and components of the embodiments herein. This is done merely for convenience and to give a general sense of the invention. This description should be read to include one or at least one and the singular also includes the plural unless it is obvious that it is meant otherwise.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof.

Therefore, it is intended that the present disclosure not be limited to the particular embodiment(s) disclosed as the best mode contemplated, but that the disclosure will include all embodiments falling within the scope of the appended claims.

What is claimed is:

1. A method for automatically determining fire risk of a property with a computer having a network connection and connected to a storage and utilizing machine learning, the method comprising the steps of:
identifying a property based upon input data received by the computer;
retrieving at least one aerial image corresponding to the property for at least one epoch;
identifying features associated with the property based on an analysis of the aerial image and based on data accessible by the machine learning stored in the storage;
identifying one or more buildings on the property;
calculating a fire score based on the identification of the features and the one or more building one the property; and
outputting the fire score.

2. The method of claim 1, wherein the step of identifying a property further comprising the steps of:
displaying the aerial image on a display coupled to the computer;
accepting a selection of a property from said aerial image; and
identifying the property based on the selection.

3. The method of claim 1, wherein the features associated with the property are selected from the group consisting of: vegetation, debris, structures, paved roadways, unpaved roadways, flammable, inflammable materials, and combinations thereof.

4. The method of claim 3, further comprising the step of:
determining a date of when the aerial image was captured;
wherein when the feature comprises vegetation, determining if the vegetation is leaf-on or leaf-off.

5. The method of claim 3, further comprising the step of:
determining a moisture level of identified vegetation features;
filtering vegetation features with respect to the identified moisture levels;
wherein the filtering provides a moisture-weighting for the vegetation features based on the identified moisture in each vegetation feature in determining the fire score.

6. The method of claim 3, wherein vector layers are associated with the identified features and are aligned with data associated with the aerial image and include pre-defined classes of content.

7. The method of claim 3, further comprising the steps of:
determining a geometry of a feature;
filtering features with respect to the identified geometry of the feature;
wherein the filtering provides a geometry-weighting for an identified feature based on the identified geometry of the feature in determining the fire score.

8. The method of claim 7, further comprising the steps of:
determining an overlap of two or more features;
filtering features with respect to the identified overlap
wherein the filtering provides overlap-weighting for an identified feature based on the identified overlap of two or more features in determining the fire score.

9. The method of claim 3, further comprising the steps of:
determining zones relative to a footprint of any identified buildings on the property, the zones being determined based on a distance from the footprint of an identified building;
wherein a fire risk weighting assigned to a feature is related, in part, to the zone in which the feature is located;
wherein features located in a zone closer to the building receive a higher zone-weighting than feature located in a zone further from the building in determining the fire score.

10. The method of claim 9, further comprising the steps of:
filtering features with respect to the determined zones and a parcel boundary associated with the property;
wherein the filtering provides a feature-weighting for an identified feature based on an identification of the feature in determining the fire score.

11. The method of claim 3, further comprising the steps of:
determining if a feature is within the parcel boundary;
filtering features based on whether the feature is fully in-parcel, fully out-of-parcel, or partly in-parcel and partly out-of-parcel;
wherein the filtering provides a parcel-weighting for an identified feature based on the determination of the location of the feature relative to the parcel boundary in determining the fire score.

12. The method of claim 3, further comprising the steps of:
determining a topology of the property;
filtering features with respect to the identified topology;
wherein the filtering provides a topology-weighting based on the identified topology of the property in determining the fire score.

13. The method of claim 3, further comprising the steps of:
obtaining a fire hazard associated with the property;
combining the fire score with the fire hazard to generate a total fire risk; and
outputting a total fire risk.

14. The method of claim 13, wherein the fire hazard for the property accounts for fuel load, temperature, wind speed, rainfall and topography adjacent to the parcel boundary.

15. The method of claim 1, wherein the aerial image comprises a file derived from at least two images.

16. The method of claim 1, wherein the at least one aerial image comprises at least two aerial images and the at least one epoch comprises at least two epochs, with at least one aerial image associated with each of the at least two epochs.

17. The method of claim 16, wherein the at least one aerial image associated with each of the at least two epochs comprises a plurality of images.

18. The method of claim 16, wherein a user may access an aerial image associated with an epoch, which is filtered by a date or a date range.
